(19) United States
(12) Patent Application Publication
(10) Pub. No.: US 2018/0022126 A1
(43) Pub. Date: Jan. 25, 2018

(54) PRINT OBJECT HOLDING TOOL, AND INKJET PRINTER HAVING THE PRINT OBJECT HOLDING TOOL

(71) Applicant: MIMAKI ENGINEERING CO., LTD., Nagano (JP)

(72) Inventors: Eiji Miyashita, Nagano (JP); Hiroyoshi Takano, Nagano (JP); Hideto Tanaka, Nagano (JP)

(73) Assignee: MIMAKI ENGINEERING CO., LTD., Nagano (JP)

(21) Appl. No.: 15/647,277

(22) Filed: Jul. 12, 2017

(30) Foreign Application Priority Data
Jul. 22, 2016 (JP) 2016-144931

(51) Int. Cl. B41J 29/28; B41J 3/407; B41F 17/00

(52) U.S. Cl. CPC B41J 29/28; B41F 17/00; B41J 3/4073

(57) ABSTRACT

The print object holding tool has a holder that holds a print object at two opposing parts thereof, a horizontal axis rotary mechanism that rotates the print object held by the holder about an axis of rotation horizontally situated; and a vertical axis rotary mechanism that rotates the print object held by the holder about an axis of rotation vertically situated.

### CROSS REFERENCE TO RELATED APPLICATIONS

This application claims the priority benefit of Japanese Patent Application No. 2016-144931, filed on Jul. 22, 2016. The entirety of the above-mentioned patent application is hereby incorporated by reference herein and made a part of this specification.

### TECHNICAL FIELD

This disclosure relates to a print object holding tool and an inkjet printer provided with the holding tool.

### DESCRIPTION OF THE BACKGROUND ART

Printers are known that are equipped to print designs on surfaces of spherical objects, for example, golf balls (for example, JP 2006-75253A). JP 2006-75253A describes an inkjet printer that prints marks or the like on the surfaces of spherical objects. Some of the known print object manufacturing apparatuses are structured to rotate print objects in predeteiuiined directions (for example, JP 2008-12297A).

### SUMMARY

An issue with the printer described in JP 2006-75253A is a limited printable area of the print object. The apparatus described in JP 2008-12297A structured to rotate spherical objects such as balls would be considerably increased in size.

To address the issues with the known art, this disclosure provides a print object holding tool that may enable efficient printing at different positions on surfaces of print objects, and an inkjet printer provided with such a holding tool.

A print object holding tool disclosed herein includes: a holder that holds a print object at two opposing parts thereof; a horizontal axis rotary mechanism that rotates the print object held by the holder about an axis of rotation horizontally situated; and a vertical axis rotary mechanism that rotates the print object held by the holder about an axis of rotation vertically situated.

The horizontal axis rotary mechanism may preferably rotate the holder.

Preferably, the print object holding tool may further include a mounting portion disposed at a vertically lower position relative to the print object held by the holder, and the vertical axis rotary mechanism may rotate the mounting portion mounted with the print object unheld by the holder, so as to rotate the print object.

Preferably, the holder may include: a first contact portion that makes contact with the print object; a second contact portion that makes contact with a part of the print object opposite to a part of the print object in contact with the first contact portion; a first mover that linearly moves the first contact portion toward and away from the print object; and a second mover that linearly moves the second contact portion toward and away from the print object.

Preferably, the horizontal axis rotary mechanism may contact a vertically lower surface of the print object held by the holder and rotate a contacted part of the vertically lower surface to rotate the print object.

Preferably, the vertical axis rotary mechanism may rotate the holder which holds the print object, with the print object being set as center of rotation.

An inkjet printer disclosed herein includes: any one of the print object holding tools described above; and a printing unit that performs inkjet printing of the print object held by the print object holding tool.

Preferably, the printing unit may prompt a carriage for the inkjet printing to move for scan in a predetermined direction. The axis of rotation of the print object by the horizontal axis rotary mechanism may be parallel to a direction in which the carriage mounted with the printing unit is moved for scan.

In this disclosure, the print object may be rotatable with its center being immovably fixed and thereby allowed to move in various directions. As a result, the print object may be effectively positioned in different directions relative to the printing unit. This may enable efficient printing at different positions on the print object's surface.

### BRIEF DESCRIPTION OF THE DRAWINGS

FIG. 1 is a drawing schematically illustrating the structure of an inkjet printer according to an embodiment.

FIG. 2 is a front view of the inkjet printer according to the embodiment.

FIG. 3 is a side view of the inkjet printer according to the embodiment.

FIG. 4 is a plan view of the inkjet printer according to the embodiment.

FIG. 5 is a perspective view of a print object holding tool according to an embodiment.

FIG. 6 is a cross-sectional view of the print object holding tool according to the embodiment.

FIG. 7 is an upper view of the print object holding tool according to the embodiment.

FIG. 8 is a perspective view of the print object holding tool in a direction that differs from the direction of the view of FIG. 5 according to the embodiment.

FIG. 9 is a bottom view of the print object holding tool according to the embodiment.

FIG. 10 is a drawing illustrating the operation of the print object holding tool according to the embodiment.

FIG. 11 is a drawing illustrating the operation of the print object holding tool according to the embodiment.

FIG. 12 is a drawing illustrating the operation of the print object holding tool according to the embodiment.

FIG. 13 is an upper view of a print object holding tool according to another embodiment.

FIG. 14 is a side view of the print object holding tool according to another embodiment.

FIG. 15 is a side view of the print object holding tool according to another embodiment.

FIG. 16 is a perspective view in a part of the print object holding tool according to another embodiment.

FIG. 17 is a cross-sectional view of the print object holding tool according to another embodiment.

FIG. 18 is a cross-sectional view of the print object holding tool according to another embodiment.

### DETAILED DESCRIPTION OF EMBODIMENTS

Hereinafter, embodiments of the inkjet printer disclosed herein are described in detail referring to the accompanying drawings. It should be understood that the embodiments are presented as non-limiting examples of this disclosure. Structural elements described in the embodiments may be replaced with other devices or easily implemented by those skilled in the art, or may be substantially identical.

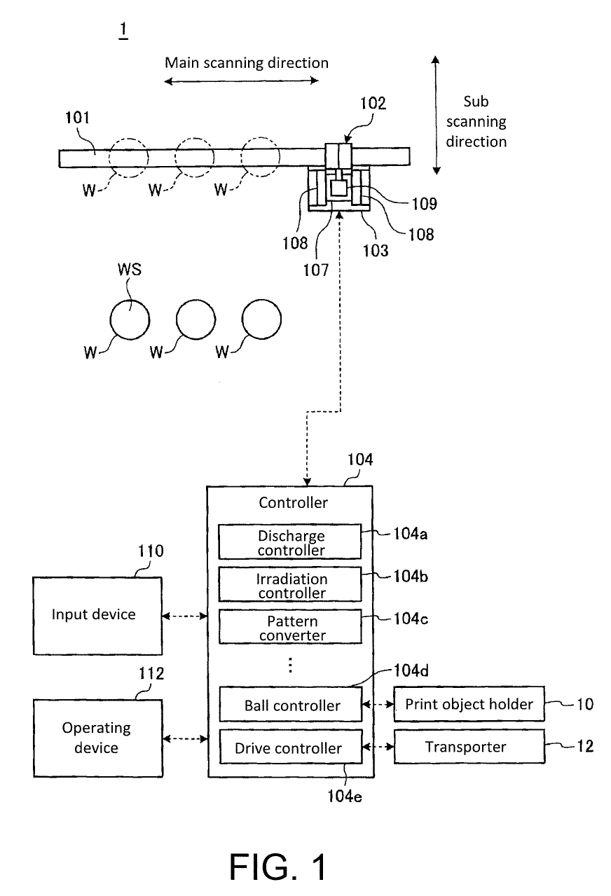

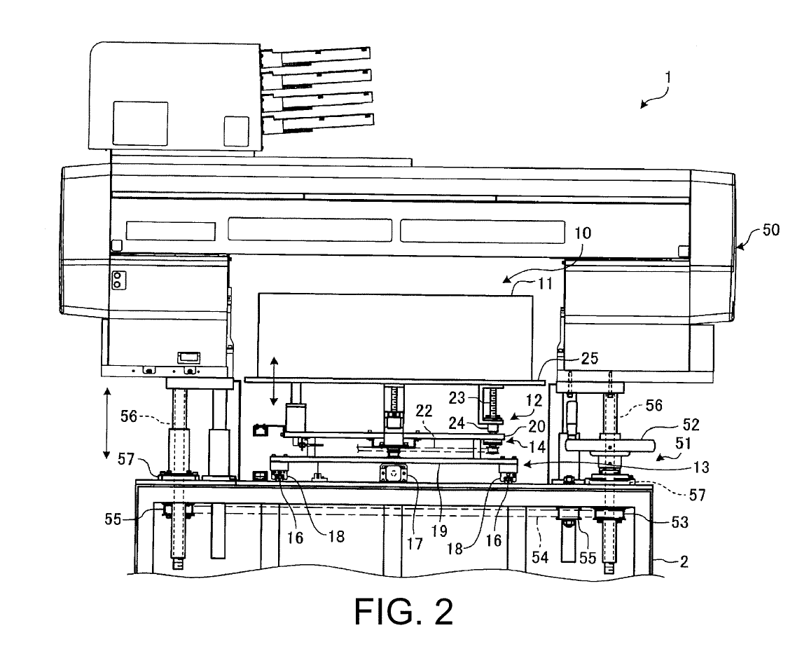

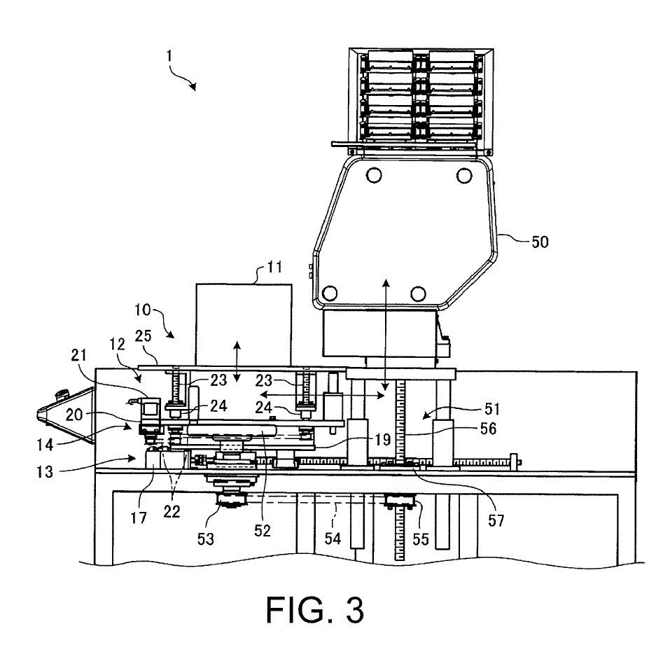

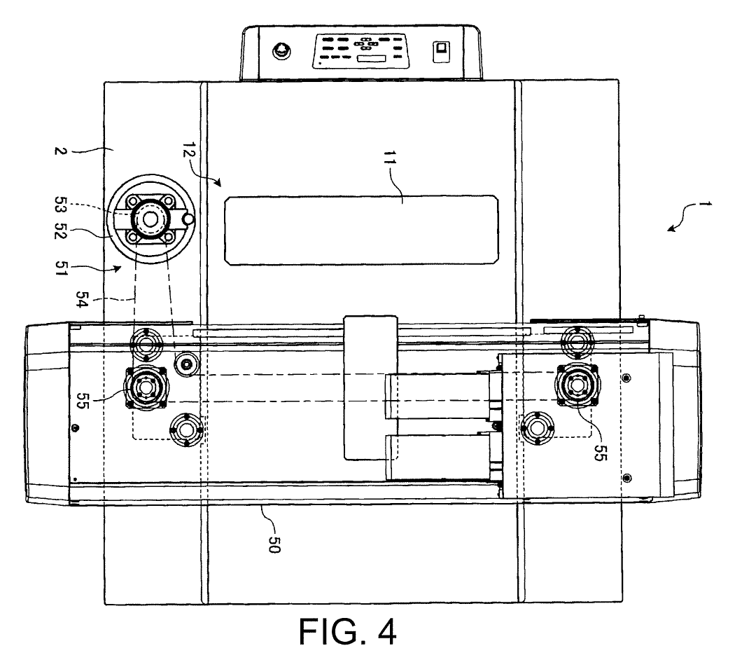

FIG. 1 is a drawing schematically illustrating the structure of an inkjet printer according to an embodiment. FIG. 2 is a front view of the inkjet printer according to the embodiment. FIG. 3 is a side view of the inkjet printer according to the embodiment. FIG. 4 is a plan view of the inkjet printer according to the embodiment.

An inkjet printer 1 illustrated in FIG. 1 discharges ultraviolet curable inks onto an outer surface WS of a print object W. The inkjet printer 1 then irradiates the outer surface WS of the print object W with ultraviolet light to cure the discharged inks and print a design or the like on the outer surface WS. An example of the print object is a spherical object. More specific examples of the print object may include golf balls, soccer balls, baseball balls, basket balls, and rugby balls. While preferable examples of the print object may be spherical or elliptical objects, polygonal objects may be used instead.

The print object W has plural coating panels bonded to the outer side of a tube-made core not illustrated in the drawings. The print object W is in a thus-configured and assembled state before a printing operation is performed by the inkjet printer 1, that is, the print object W to be printed by the inkjet printer 1 according to the disclosure is a state of a finished product of a print object except that printing has not been formed yet. The print object W has a basic design already printed on the outer surface WS before a new design or the like is further printed thereon by the inkjet printer 1. Examples of the basic design may include letters, pictures, and graphics.

The inkjet printer 1 further prints a new design on the outer surface WS of the spherical print object W. As illustrated in FIGS. 2 to 4, the inkjet printer 1 has a print object holder 10 that holds the print object W, a rough positioning adjuster 51, a printing unit 50 disposed above the print object holder 10 to print a design on the outer surface WS of the print object W, and a controller 104.

The print object holder 10 has a print object holding tool 11 disposed on the printer body 2 of the inkjet printer 1 to hold the print object W, and a transporter 12 that transports the print object holding tool 11 to and from a mounting position (illustrated with a solid line in FIG. 1) and a printing position (illustrated with a two-dot chain line in FIG. 1).

The print object holding tool 11 is set on the transporter 12. The print object holding tool 11 is equipped to hold the print object W with their vertically upper surfaces being exposed, i.e., surfaces facing the printing unit 50 being exposed. The print object holding tool 11 is further equipped to hold plural print objects W, rotate and redirect the print objects W. The print object holding tool 11 will be further described later.

The transporter 12 moves the print object holding tool 11 in parallel to the sub scanning direction of a carriage 103 mounted with the printing unit 50, thereby moving the print object holding tool 11 to and from the mounting position and the printing position. The mounting position described herein refers to a position at which the print object is loaded in the print object holding tool 11 and removed from the print object holding tool 11 after the printing is finished. The printing position described herein refers to a position at which a design or the like is printed by the printing unit 50 on the print object W held by the print object holding tool 11 located below the printing unit 50.

The transporter 12 has a horizontal mover 13 that moves the print object holding tool 11 in parallel to the sub scanning direction, and a precision positioning adjuster 14 that vertically moves the print object holding tool 11.

The horizontal mover 13 is disposed on the printer body 2. The horizontal mover 13 has a plurality of guide rails 16 parallel to the sub scanning direction. The guide rails 16 have sliders 18 movably fitted therein. The horizontal mover 13 further has a motor 17 that drives lead screws parallel to the sub scanning direction, not shown, to rotate about their axes, nuts engaged with the lead screws, and a horizontal movement table 19 attached to the sliders 18. As the lead screws are rotated about their axes by the motor 17, the horizontal mover 13 moves the horizontal movement table 19, i.e., the print object holding tool 11, to and from the mounting position and the printing position in the sub scanning direction.

The precision positioning adjuster 14 vertically moves the print object holding tool 11 and thereby changes a vertical distance between the outer surface WS of the print object W held by the print object holding tool 11 and the carriage 103 mounted with the printing unit 50. The precision positioning adjuster 14 is supported by the horizontal movement table 19 of the horizontal mover 13. The precision positioning adjuster 14 has an immovable table 20 fixed on the horizontal movement table 19, a motor 21 attached to the immovable table 20, lead screws 23 rotatable about their axes parallel to the vertical direction under the driving force of the motor 21 transmitted via a belt 22, and a vertical movement table 25 attached to nuts 24 engaged with the lead screws 23 or the like. The vertical movement table 25 is disposed at a position in the upper direction of the immovable table 20. The vertical movement table 25 vertically moves as the lead screws 23 are rotated by the motor 21. The print object holding tool 11 is attached to and supported by the vertical movement table 25. As the lead screws 23 are rotated about their axes by the motor 21, the precision positioning adjuster 14 vertically moves the vertical movement table 25, i.e., the print object holding tool 11.

An operator manipulates the rough positioning adjuster 51 to change the vertical distance between the outer surface WS of the print object W held by the print object holding tool 11 and the carriage 103 mounted with the printing unit 50 that prints a design on the outer surface WS. In this embodiment, an operator manipulates the rough positioning adjuster 51 to vertically move the printing unit 50 with the carriage 103 relative to the printer body 2.

As illustrated in FIGS. 2 to 4, the rough positioning adjuster 51 has a rotary handle 52 disposed on the printer body 2, a pair of rotatable pulleys 55, and a pair of lead screws 56. The rotary handle 52 is rotatable on the printer body 2 about its axis parallel to the vertical direction. Endless belts 54 are hung across the paired pulleys 55 to the pulleys 53 attached to the rotary handle 52. The paired lead screws 56 are engaged with nuts 57 of the pulleys 55 and attached to the printing unit 50. The paired pulleys 55 and the lead screws 56 are disposed at positions in the main scanning direction between which the print object holding tool 11 at the printing position is interposed. An operator rotates the rotary handle 52 about its axis, in response to which the rough positioning adjuster 51 rotates the lead screws 56 about their axes via the pulleys 55 or the like to vertically move the printing unit 50.

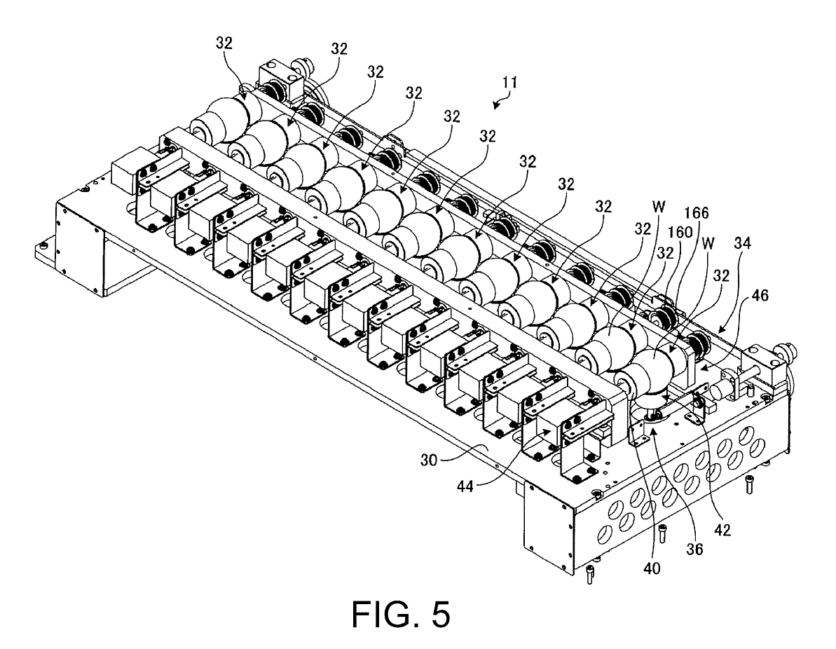

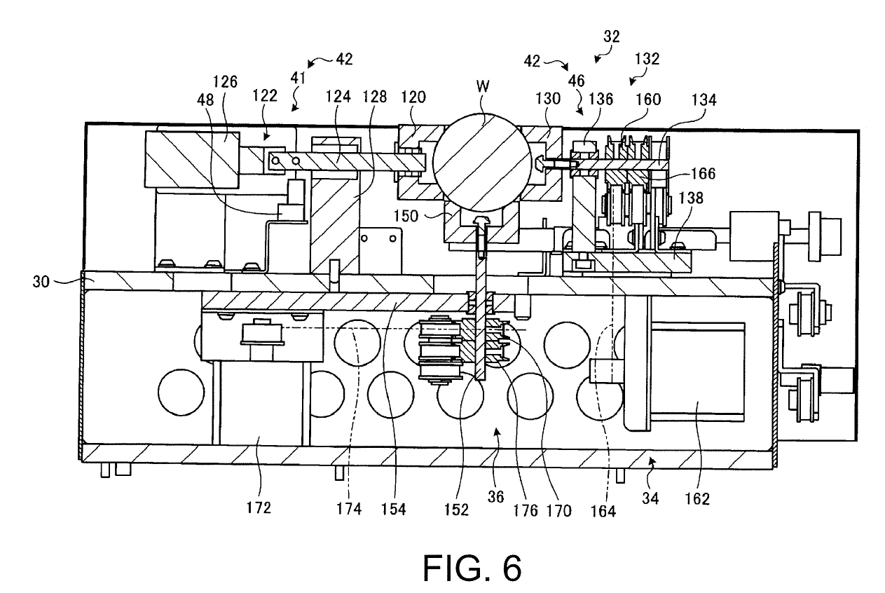

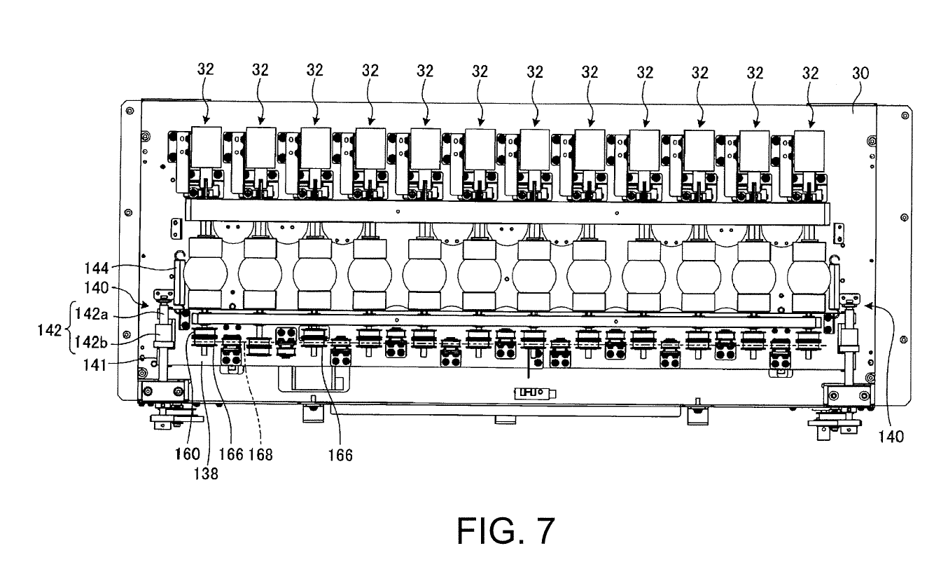

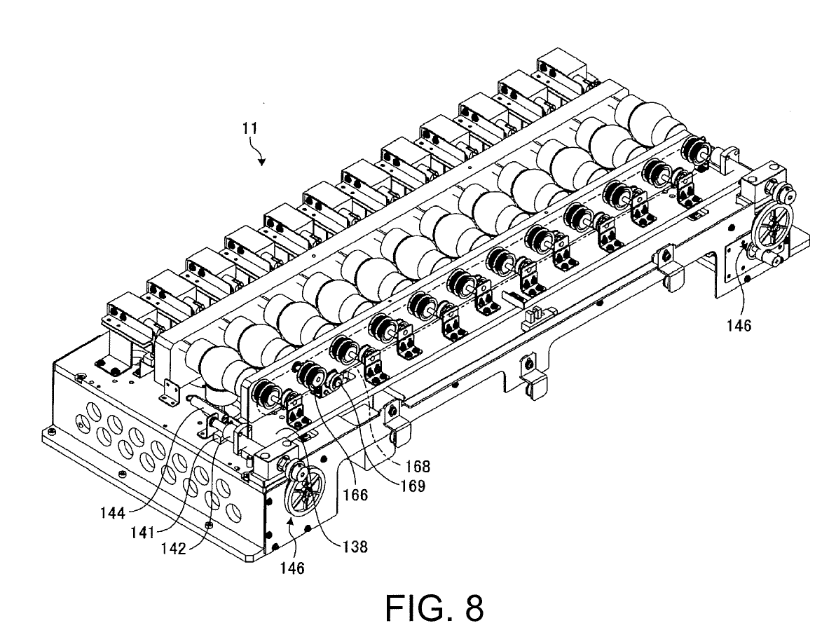

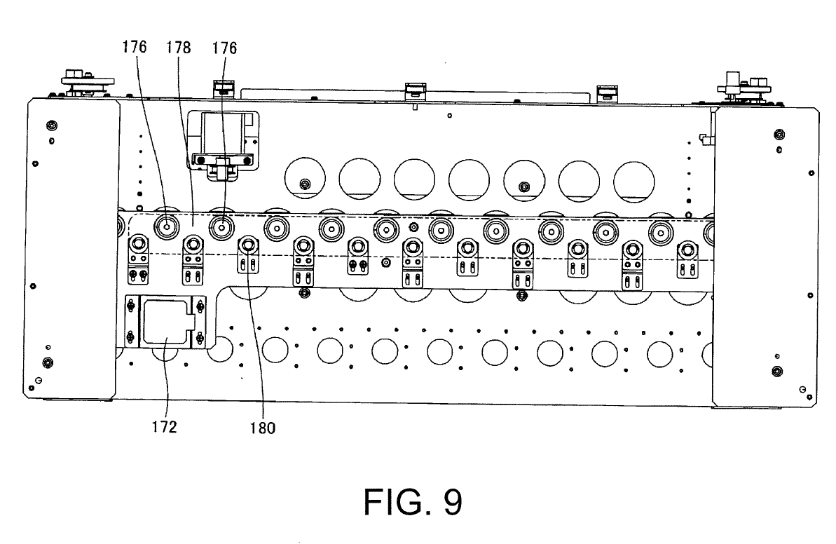

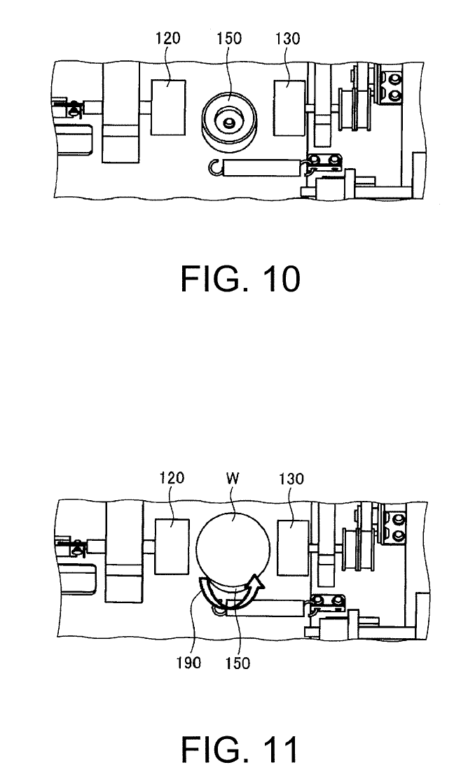

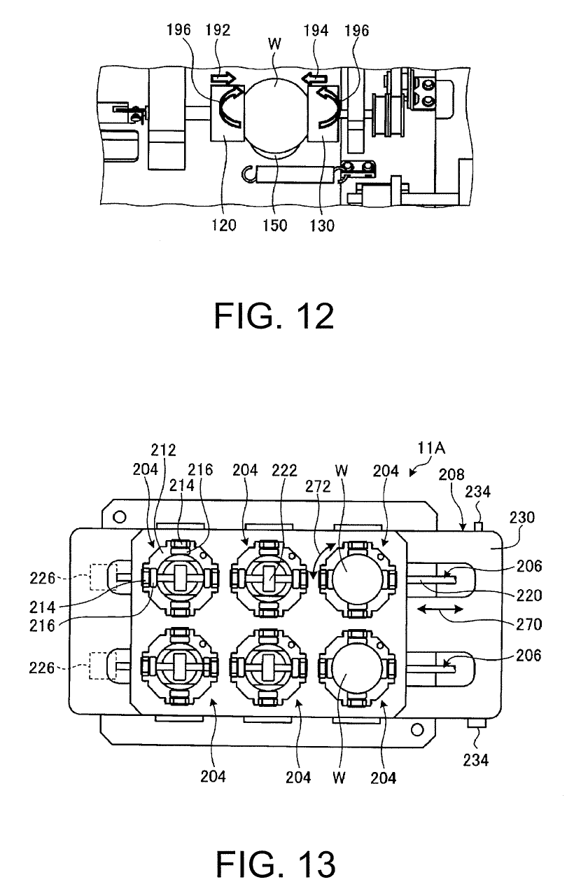

The print object holding tool 11 is now described referring to FIGS. 5 to 12. FIG. 5 is a perspective view of the print object holding tool 11 according to the embodiment. FIG. 6 is a cross-sectional view of the print object holding tool 11 according to the embodiment. FIG. 7 is an upper view of the print object holding tool 11 according to the embodiment. FIG. 8 is a perspective view of the print object holding tool 11 in a direction that differs from the direction of the view of FIG. 5 according to the embodiment. FIG. 9 is a bottom view of the print object holding tool 11 according to the embodiment. FIGS. 10 to 12 are drawings illustrating the operation of the print object holding tool 11 according to the embodiment, respectively.

The print object holding tool 11 has a base 30, a plurality of per-print object holders 32, a horizontal axis rotation driver 34, and a vertical axis rotation driver 36. The print object holding tool 11 according to this embodiment is provided with twelve per-print object holders 32. The base 30 is secured to the vertical movement table 25 of the transporter 12. The base 30 supports the per-print object holders 32, horizontal axis rotation driver 34, and vertical axis rotation driver 36.

The per-print object holders 32 each hold and rotate one print object. The twelve per-print object holders 32 are disposed in alignment, so that the print objects W thereby held are arranged in a row. The per-print object holders 32 are essentially similarly structured. A description is hereinafter given to one per-print object holder 32.

The per-print object holder 32 has a print object holder 40 and a print object rotator 42. The print object holder 40 has a first arm 44, a second arm 46, and a position sensor 48. The print object holder 40 inserts the print object W into between the first aim 44 and the second arm 46, so as to securely hold the print object W.

The first arm 44 includes a first contact portion 120 and a first mover 122. The first contact portion 120 is at one end of the first arm 44 closer to the second aim 46. A surface of the first contact portion 120 closer to the second arm 46 contacts the print object W. The first contact portion 120 is a ring-shaped portion whose surface closer to the second arm 46 has a cavity on its inner side. The first contact portion 120 contacts the print object W at a position at which the center line of the ring shape coincides with the center of the print object W. The surface of the first contact portion 120 closer to the second arm 46 is inclined along the curved surface of the print object W. Specifically, the first contact portion 120 is inclined toward its center in a direction away from the second arm 46. This surface may preferably be inclined along the curved surface of the print object W. The inclined surface may be a curved surface or a flat surface. The first contact portion 120 is flexible enough to prevent any damage to the print object W and rigid enough to hold the print object W. An exemplified material of the first contact portion 120 may be polyacetal.

The first mover 122 linearly moves the first contact portion 120. The first mover 122 horizontally moves the first contact portion 120 in directions orthogonal to the direction in which the per-print object holders 32 are arranged. The first mover 122 moves in directions in which the first contact portion 120 is drawn closer to and away from the print object W held between the first arm 44 and the second arm 46. The first mover 122 has a shaft 124, a linear driver 126, and a support portion 128. The shaft 124 is located so that its axial direction is along the moving directions of the first contact portion 120. The shaft 124 supports the first contact portion 120 in an axially rotatable manner. The linear driver 126 has a solenoid actuator and a compression spring. The linear driver 126 moves the shaft 124 in the axial direction thereof The linear driver 126 moves the shaft 124 away from the print object W using the solenoid actuator, and moves the shaft 124 toward the print object W using the compression spring. While the linear driver 126 is regulating the position of the shaft 124 using the solenoid actuator, the first contact portion 120 is at a position distant from the print object W. While the position of the shaft 124 is being unregulated by the solenoid actuator, the first contact portion 120 is at a position near the print object W by the force of the compression spring. The support portion 128 is secured to the base 30 and supports the shaft 124 in an axially movable manner. By leveraging the biasing force of the compression spring to move the shaft 124 to a position near the print object W, the first contact portion 120 is forced into contact with the print object W under a predetermined pressure.

The second arm 46 includes a second contact portion 130, a second mover 132, a shaft 134, a support portion 136, a substructure 138, and base linear movement mechanisms 140. The second contact portion 130 is at one end of the second arm 46 closer to the first arm 44. A surface of the second contact portion 130 closer to the first arm 44 contacts the print object W. As with the first contact portion 120, the second contact portion 130 is a ring-shaped portion whose surface closer to the first aim 44 has a cavity on its inner side. The second contact portion 130 contacts the print object W at a position at which the center line of the ring shape coincides with the center of the print object W. The surface of the second contact portion 130 closer to the first arm 44 is inclined along the curved surface of the print object W. Specifically, the second contact portion 130 is inclined toward its center in a direction away from the first arm 44. This surface may preferably be inclined along the curved surface of the print object W. The inclined surface may be a curved surface or a flat surface. The second contact portion 130 is flexible enough to prevent any damage to the print object and rigid enough to hold the print object W. An exemplified material of the second contact portion 130 may be polyacetal.

The second mover 132 linearly moves the second contact portion 130. The second mover 132 horizontally moves the second contact portion 130 in directions orthogonal to the direction in which the per-print object holders 32 are arranged. The second mover 132 moves in directions in which the second contact portion 130 is drawn closer to and away from the print object W held between the first arm 44 and the second arm 46. The second mover 132 has the shaft 134, the support portion 136, the substructure 138, and the base linear movement mechanisms 140. The shaft 134 is situated so that its axial direction is along the moving directions of the second contact portion 130. The shaft 134 is secured to the second contact portion 130. The shaft 134 is coupled to the horizontal axis rotation driver 34. The support portion 136 is secured to the substructure 138 and supports the shaft 134 in an axially movable manner. As illustrated in FIGS. 7 and 8, the substructure 138 and the base linear movement mechanisms 140 are for all of the twelve per-print object holders 32. The support portions 136 of the twelve per-print object holders 32 are secured to one substructure 138. The substructure 138 has cutouts 141 for movable elements of the base linear movement mechanisms 140 to be inserted. The substructure 138 has two base linear movement mechanisms 140. The base linear movement mechanisms 140 each have a linear movement mechanism 142 and a tension spring 144. The linear movement mechanism 142 has a stationary element 142a and a movable element 142b. The stationary element 142a of the linear movement mechanism 142 includes a print object screw rotatably supported on the base 30, and the movable element 142b is a plate-shaped member. When the print object screw is inserted in the movable element 142b and then rotated, the movable element 142b moves in the axial direction of the print object screw. The movable elements 142b are inserted in the cutouts 141. The two base linear movement mechanisms 140 are linked to each other by linkages 146. The linkages 146 are connected with a belt not illustrated in the drawings and rotate in conjunction with the print object screws of the stationary elements 142a. One end of the tension spring 144 is secured to the base 30, while other end thereof is secured to the substructure 138. The tension spring 144 serves to pull the substructure 138 toward the print object W. The base linear movement mechanisms 140 move the substructure 138, thereby moving the shaft 134 securely positioned via the support portion 136 in the axial direction of the shaft 134. The base linear movement mechanisms 140 cause the movable element 142b of the linear movement mechanism 142 to contact one end surface of the cutout 141 farther from the print object W than the other, and then move the movable element 142b away from the print object W, thereby moving the shaft 134 away from the print object W. The base linear movement mechanisms 140 cause the movable element 142b of the linear movement mechanism 142 to contact one end surface of the cutout 141 farther from the print object W than the other, and then move the movable element 142b toward the print object W, thereby moving the shaft 134 toward the print object W. The base linear movement mechanisms 140 move the substructure 138 by pulling the substructure 138 using the tension spring 144 toward the print object W, so as to follow the movement of the movable element 142b of the linear movement mechanism 142. While the print object W and the second contact portion 130 are staying in contact with each other, the movable element 142b of the linear movement mechanism 142 is moved toward the print object W. Then, the second contact portion 130 is caused into contact with the print object W under a predetermined pressure by the tensile force of the tension spring 144.

The print object rotator 42 is coupled to and rotated by the vertical axis rotation driver 36 about the vertical axis, thereby rotating the print object W about the vertical axis. The print object rotator 42 has a mounting portion 150, a shaft 152, and a support portion 154. The mounting portion 150 is disposed at a position between the first contact portion 120 of the first aim 44 and the second contact portion 130 of the second aim 46 on the vertically lower side than the first contact portion 120 and the second contact portion 130. The mounting portion 150 is disposed at a position vertically right below the position of the print object W held by the first contact portion 120 and the second contact portion 130. There is a clearance between the mounting portion 150 according to this embodiment and the print object W held by the first contact portion 120 and the second contact portion 130. This prevents any contact of the mounting portion 150 with the print object W held by the first contact portion 120 and the second contact portion 130. The clearance between the mounting portion 150 and the print object W held by the first contact portion 120 and the second contact portion 130 may be, for example, 5 mm. A range of values may preferably be defined as the clearance, and, numerical values of the clearance can be set in suitable ranges. The mounting portion 150 is a ring-shaped portion whose vertically upper surface has a cavity on its inner side. The mounting portion 150, when mounted with the print object W unheld by the first contact portion 120 and the second contact portion 130, contacts the print object W at a position at which the center line of the ring shape coincides with the center of the print object W. The vertically upper surface of the mounting portion 150 is inclined along the curved surface of the print object W. Specifically, the mounting portion 150 is inclined vertically downward toward its center. This surface may preferably be inclined along the curved surface of the print object W. The inclined surface may be a curved surface or a flat surface. The mounting portion 150 is flexible enough to prevent any damage to the print object W and rigid enough to hold the print object W. An exemplified material of the mounting portion 150 may be polyacetal. The shaft 152 is situated so that its shaft center coincides with the center line of the ring shape of the mounting portion 150, and the mounting portion 150 is securely fixed. The vertical axis rotation driver 36 is coupled to the shaft 152. The shaft 152 is rotated by the vertical axis rotation driver 36. The support portion 154 is secured to and supported by the base 30, with the shaft 152 being rotatable but vertically immovable.

The position sensor 48 detects the position of the shaft 124 in its moving directions. At a position at which the print object W should be held by the print object holder 40, the position sensor 48 detects whether the print object W is currently in the mounting portion 150 based on the position of the shaft 124. In case the print object W is currently not in the mounting portion 150, the shaft 124 moves by at least a predetermined distance toward the second contact portion 130, i.e., the shaft 124 moves to a position closer to the second contact portion 130 than positions of movements of the print object W and the first contact portion 120. In case the shaft 124 is not at a position closer to the second contact portion 130 than positions of movements of the print object W and the first contact portion 120, the position sensor 48 determines that the print object W is currently in the mounting portion 150. In case the shaft 124 is at a position closer to the second contact portion 130 than positions of movements of the print object W and the first contact portion 120, the position sensor 48 determines that the print object W is currently not in the mounting portion 150.

The horizontal axis rotation driver 34 rotates the print object W about a horizontally extending axis passing through the center of the print object W. The axis of rotation of the print object by the horizontal axis rotation driver 34 is parallel to the direction in which the carriage mounted with the printing unit is moved for scan. The horizontal axis rotation driver 34 is a common component for all of the twelve per-print object holders 32. The horizontal axis rotation driver 34 is coupled to and rotates the shafts 134 of the second aims 46 of the twelve per-print object holders 32. As illustrated in FIGS. 5 to 8, the horizontal axis rotation driver 34 has gears 160, a driver 162, a belt 164, gears 166, a belt 168, and pulleys 169. The gears 160 are secured to the shafts 134. The driver 162 is a motor that drives the axis of rotation to rotate. The belt 164 is hung across the gears 160 to the axis of rotation of the driver 162. The gears 166 are secured to the shafts 134 of the twelve per-print object holders 32. The belt 168 is laid around the gears 166 secured to the shafts 134 of the twelve per-print object holders 32. The belt 168 is laid around the pulleys 169. This allows the belt 168 to stay in contact with the gears 166 under certain tension.

The vertical axis rotation driver 36 rotates the print object W about a vertically extending axis passing through the center of the print object W. The horizontal axis rotation driver 34 rotates the driver 162 and transmits the rotary power of the driver 162 to the gears 160 through the belt 164. The horizontal axis rotation driver 34 thereby rotates the shafts 134 to which the gears 160 are secured, consequently rotating the second contact portions 130 via the shafts 134 to which the gears 160 are secured. The horizontal axis rotation driver 34 rotates the shafts 134 and accordingly rotates the gears 166, and further rotates the other gears 166 using the belt 168 laid around the gears 166, thereby rotating the shafts 134 of the per-print object holders 32 uncoupled to the driver 162 with the belt 164. The horizontal axis rotation driver 34 thus rotates the shafts 134 of the twelve per-print object holders 32 in conjunction with one another.

The vertical axis rotation driver 36 is a common component for all of the twelve per-print object holders 32. The vertical axis rotation driver 36 is coupled to and rotates the shafts 152 of the print object rotators 42 of the twelve per-print object holders 32. As illustrated in FIGS. 5, 6, and 9, the vertical axis rotation driver 36 has gears 170, a driver 172, a belt 174, gears 176, a belt 178, and pulleys 180. The gears 170 are secured to the shafts 152. The driver 172 is a motor that drives the axis of rotation to rotate. The belt 174 is hung across the gears 170 to the axis of rotation of the driver 172. The gears 176 are secured to the shafts 152 of the twelve per-print object holders 32. The belt 178 is laid around the gears 176 secured to the shafts 152 of the twelve per-print object holders 32. The belt 178 is laid around the pulleys 180. This allows the belt 178 to stay in contact with the gears 176 under certain tension.

The vertical axis rotation driver 36 rotates the driver 172 and transmits the rotary power of the driver 172 to the gears 170 through the belt 174. The vertical axis rotation driver 36 thereby rotates the shafts 152 to which the gears 170 are secured, consequently rotating the mounting portion 150 via the shafts 152 to which the gears 170 are secured. The vertical axis rotation driver 36 rotates the shafts 152 and accordingly rotates the gears 176, and further rotates the other gears 176 using the belt 178 laid around the gears 176, thereby rotating the shafts 152 of the per-print object holders 32 uncoupled to the driver 172 with the belt 174. The vertical axis rotation driver 36 thus rotates the shafts 152 of the twelve per-print object holders 32 in conjunction with one another.

The operation of the print object holding tool 11 is described below referring to FIGS. 10 to 12. The print object holding tool 11, when the print object W is not held therein, locates the first contact portion 120 and the second contact portion 130 at positions spaced apart, as illustrated in FIG. 10. The print object holding tool 11 moves the first contact portion 120 to a position away from the second contact portion 130 using the first mover 122, and moves the second contact portion 130 to a position away from the first contact portion 120 using the second mover 132.

With the first contact portion 120 and the second contact portion 130 being spaced apart as illustrated in FIG. 10, the print object W is mounted in the mounting portion 150 of the print object holding tool 11 as illustrated in FIG. 11. At the time, there is no contact between the print object W, the first contact portion 120, and the second contact portion 130. In the state illustrated in FIG. 11, the print object holding tool 11 rotates the mounting portion 150 using the vertical axis rotation driver 36, thereby rotating the print object W about the vertical axis as illustrated with an arrow 190.

With the print object W being mounted in the mounting portion 150, the print object holding tool 11 then moves the first contact portion 120 using the first mover 122 toward the print object W (arrow 192) to cause the first contact portion 120 to be into contact with the print object W. Further, the print object holding tool 11 moves the second contact portion 130 using the second mover 132 toward the print object W (arrow 194) to cause the second contact portion 130 to be into contact with the print object W. As a result, the print object W is interposed between and held by the first contact portion 120 and the second contact portion 130. The first contact portion 120 and the second contact portion 130 at the time are subjected to a spring-generated biasing force directed toward the print object W and thereby thinly hold the print object W. The print object W thus interposed between and held by the first contact portion 120 and the second contact portion 130 moves toward the vertically upper side than the mounting portion 150, and thereby losing contact with the mounting portion 150. In this state, the second contact portion 130 is rotated by the horizontal axis rotation driver 34, and the first contact portion 120 rendered rotatable starts to rotate as well. As a result, the first contact portion 120 and the second contact portion 130 and the print object W thereby held rotate about the horizontal axis as illustrated with an arrow 196.

In this manner, the print object W is rotated by the print object holding tool 11 about the horizontal and vertical axes. The print object holding tool 11 according to this embodiment linearly moves both of the first contact portion 120 and the second contact portion 130. Instead, one of these portions may be immovably secured.

The printing unit 50 performs inkjet printing by discharging inks. As illustrated in FIG. 1, the printing unit 50 has a Y bar 101 extending in the main scanning direction, an ink tank 102, and a carriage 103. The ink tank 102 contains inks to be discharged onto the outer surface WS of the print object W located by the print object holding tool 11 at the printing position. In the ink tank 102, M (magenta), C (cyan), Y (yellow), and K (black) inks are stored in different containers. The degrees of cure of the inks stored in the ink tank 102 are variable under exposure to ultraviolet light.

By moving the carriage 103, a new design is printed on the outer surface WS of the print object W located at the printing position by the print object holding tool 11. The carriage 103 is allowed to reciprocate along the Y bar 101 in the main scanning direction parallel to the horizontal direction. As the carriage 103 mounted with an ink discharger 109 discharging the inks and ultraviolet irradiators 108 irradiating the inks with ultraviolet light moves in the main scanning direction, a new design is printed on the outer surface WS of the print object W. The carriage 103 is moved in the direction (main scanning direction) orthogonal to the transport direction of the print object W (sub scanning direction). The carriage 103 has a holder 107 and a pair of ultraviolet irradiators 108. The ultraviolet irradiators are disposed on both sides of the holder 107 in the main scanning direction.

The ink discharger 109 is mounted in the holder 107 of the carriage 103. The ink discharger 109 has a plurality of discharge nozzles (not illustrated in the drawings) so as to discharge through the nozzles any one(s) of the M (magenta), C (cyan), Y (yellow), and K (black) inks stored in the ink tank 102. The ink discharger 109 discharges through the discharge nozzles any one(s) of the color inks depending on a design to be printed on the print object. The before-mentioned inks discharged from the ink discharger 109 may be replaced with a different combination of color inks. The ink discharger 109 includes a printer head unit facing the print object W for ink discharge, ink flow paths that connect the ink tank 102 to the printer head, and regulators and pumps disposed in the ink flow paths.

The printer head unit includes at least an ink discharge head. The printer head units are connected to the ink tank 102 via the ink flow paths. By driving the pumps using piezoelectric elements, the discharge nozzles of the ink discharger 109 discharge the inks of the ink tank 102 in predetermined quantities through the heads of the printer head units toward the print object W by the discharging method.

The ultraviolet irradiators 108 irradiate the inks discharged on the print object W with ultraviolet light. The ultraviolet irradiators 108 may include ultraviolet-emitting LED modules.

The controller 104 controls the components of the inkjet printer 1, including the transporter 12, ink discharger 109, and ultraviolet irradiators 108. The controller 104 includes the following functional elements; a discharge controller 104a, an irradiation controller 104b, a pattern converter 104c, a ball controller 104d, and a drive controller 104e. The controller 104 includes a computing device, hardware devices such as memory, and programs to execute predetermined functions of these devices.

The discharge controller 104a of the controller 104 controls the piezoelectric elements that drive the pumps for the discharge nozzles of the ink discharger 109 or the like, thereby regulating the quantity, timing, and duration of the ink discharge through the discharge nozzles. The irradiation controller 104b controls the ultraviolet irradiators 108 or the like to regulate the intensity of ultraviolet light radiated from each ultraviolet irradiator 108 and the timing and duration of irradiation. The pattern converter 104c is used to set levels of discharge control and irradiation control depending on information inputted from PC and an input device 110 including various terminals that are connected with a wire or wirelessly to the controller 104.

The information inputted to the pattern converter 104c may include image-related information inputted through the input device 110, for example, a new design (for example, letter, picture, diagram) to be printed on the outer surface WS of the print object W. Based on the inputted information, the pattern converter 104c creates a print pattern that forms a new design to be printed on the outer surface WS of the print object W. The pattern converter 104c then converts the print pattern into levels of discharge control and irradiation control by which the created print pattern is feasible. The discharge controller 104a controls the ink discharge of each discharge nozzle of the ink discharger 109 based on the level of discharge control obtained by the pattern converter 104c. The irradiation controller 104b controls ultraviolet light radiated from each ultraviolet irradiator 108 based on the level of irradiation control obtained by the pattern converter 104c.

The ball controller 104d controls the operations of the devices of the print object holder 10. The drive controller 104e creates drive patterns of the motors 17 and 21 of the transporter 12 based on the prestored programs, and controls the motors 17 and 21 of the transporter 12 based on the created drive patterns.

The controller 104 controls the operations of the transporter 12, the printing unit 50 or the like depending on instructions inputted from an operating device 112 including buttons and switches. The operating device 112 is also used to suitably change the position and size of a new design to be printed by the printing unit 50 or to select a different design.

While a design is being printed on the print object W with the inks discharged from the ink discharger 109, the controller 104 detects, using a sensor of the printing unit 50 not illustrated in the drawings, a vertical distance between the discharge nozzles of the carriage 103 and the discharged ink-adhered outer surface WS of the print object W held by the print object holding tool 11. During the printing operation carried out by the carriage 103, the controller 104 prompts the motor 21 of the precision positioning adjuster 14 to appropriately adjust the vertical distance detected by the sensor.

The inkjet printer 1 thus structured is prompted by the controller 104 to reciprocate the carriage 103 in the main scanning direction relative to the print object W located in the print object holding tool 11 at the printing position and prompt the ink discharger 109 to discharge the inks in predetermined print widths onto the outer surface WS of the print object W. Then, the inkjet printer 1, under the control by the controller 104, prompts the ultraviolet irradiators 108 to irradiate the discharged inks on the print object W with ultraviolet light at predetermined timings to cure the inks. While the carriage 103 is moving, a new design is thus printed on the outer surface WS of the print object W.

The inkjet printer 1 changes voltages applied to drive the piezoelectric elements of the discharge nozzles depending on the distance between the discharge nozzles and the discharged ink-adhered outer surface WS of the print object W, thereby increasing the ink to be discharged and the rate of ink discharge. To increase the ink to be discharged, the size of ink each droplet may be increased. Otherwise, because of a slower rate of earlier ink discharge than ink discharge that immediately follows, intervals of the ink discharge may be narrowed to join the inks before landing on the print object.

In accordance with the predetermined printing widths, the inkjet printer 1 moves the print object W at the printing position relative to the carriage 103 in the transport direction (sub scanning direction) using the transporter 12, and vertically moves the print object W held by the print object holding tool 11 using the motor 21 of the precision positioning adjuster 14. The inkjet printer 1, by repeatedly prompting these movements, prints a new design on the outer surface WS of the print object W. Further, the inkjet printer 1 rotates the print object W about the horizontal axis using the print object holding tool 11, so that an unprinted surface of the print object is relocated to a position facing the carriage 103. Further, the inkjet printer 1 rotates the print object W about the vertical axis using the print object holding tool 11 and then rotates the print object W about the horizontal axis, thereby moving the print object held by the print object holder 40 to a position facing the carriage 103. By thus rotating the print object W using the print object holding tool 11, the inkjet printer 1 moves the print object W at different positions to a position facing the carriage 103. The discharge controller 104a of the controller 104 controls the quantity, timing, and duration of the ink discharge through the discharge nozzles of the ink discharger 109, while the irradiation controller 104b of the controller 104 controls the intensity of ultraviolet light radiated from each ultraviolet irradiator 108. In this manner, the inkjet printer 1 prints a new design on the outer surface WS of the print object W in accordance with the print pattern created by the pattern converter 104c.

The inkjet printer 1 according to this embodiment described so far rotates the print object W about the horizontal and vertical axes using the print object holding tool 11. This allows different parts of the print objects W held by the print object holding tool 11 to be directed toward the carriage. Such a simplified structure may afford effective change of the print surface of the print object W, leading to an improved efficiency of the printing operation. This structure that allows the print object W to be rotated with substantially no displacement of its center axis may afford quick change of the print surface.

The ring-shaped contact surfaces of the first contact portion 120 and the second contact portion 130 allow the print object holding tool 11 to hold the print object W at a position at which the axes of rotation of the first contact portion 120 and the second contact portion 130 are passing through the center of the print object W. Relative displacement is possible between the axes of rotation and the center of the print object W when the print object W in the mounting portion 150 is held by the first contact portion 120 and the second contact portion 130. The print object W, however, may be relocated to a position at which the center of the print object W coincides with the axes of rotation. Thus moving the print object W avoids contact between the mounting portion 150 and the print object W held between the first contact portion 120 and the second contact portion 130. The inclined contact surfaces of the first contact portion 120 and the second contact portion 130 allow for smooth movement of the print object W when held by the first contact portion 120 and the second contact portion 130.

The position sensor 48 allows the print object holding tool 11 to determine whether the print object W is loaded in the per-print object holder 32.

The inkjet printer 1, using the rough positioning adjuster 51, roughly adjusts the vertical distance between the ink discharger 109 in the carriage 103 and the outer surface WS of the print object W held by the print object holding tool 11. During the printing operation, the precision positioning adjuster 14 is prompted by the controller 104 to appropriately adjust the vertical distance between the ink discharger 109 in the carriage 103 and the outer surface WS of the print object W. This inkjet printer 1 that uses the print object holding tool 11 to hold the print object W may enable printing of variously shaped print objects, while saving time-consuming labor associated with preparations.

The inkjet printer 1 prompts the rough positioning adjuster 51 to roughly adjust the vertical distance between the ink discharger 109 of the carriage 103 and the outer surface WS of the print object W held by the print object holding tool 11. This helps to reduce a range of adjustments of the vertical distance between the ink discharger 109 of the carriage 103 and the outer surface WS of the print object W to be done by the precision positioning adjuster 14 during the printing operation. The inkjet printer 1 may accordingly reduce a range of vertical movements of the print object holding tool 11 prompted by the precision positioning adjuster 14 during the printing operation. In case the print object holding tool 11 is vertically moved during the printing operation, the inkjet printer 1 may still reduce required time for printing of the outer surface WS of the print object W.

The transporter 12 of the inkjet printer 1 has the horizontal mover 13 that moves the print object holding tool 11 in the sub scanning direction. Therefore, the print object W held by the print object holding tool 11 is allowed to move in the sub scanning direction, if necessary, during the printing operation, further promising successful printing of surfaces WS of variously shaped print objects W. The transporter 12 moves the print object holding tool 11, i.e., the print object W thereby held, in the sub scanning direction relative to the carriage 103. The print object W is thereby movable at higher speeds in the sub scanning direction than when the printing unit 50 is moved in the sub scanning direction.

In the inkjet printer 1, the precision positioning adjuster 14 is supported on the horizontal movement table 19 of the horizontal mover 13. This precision positioning adjuster 14 vertically moves the print object holding tool 11, i.e., the print object W thereby held. As compared to when the printing unit 50 is vertically moved, the inkjet printer 1 having the precision positioning adjuster 14 may more quickly adjust the distance between the outer surface WS of the print object W and the ink discharger 109 of the carriage 103.

The inkjet printer 1 prompts the rough positioning adjuster 51 to vertically move the printing unit 50. The rough positioning adjuster 51 vertically moves the printing unit 50, while the precision positioning adjuster 14 moves the print object holding tool 11. After the position of the printing unit 50 is adjusted by the rough positioning adjuster 51, the position of the print object holding tool 11 is adjusted during the printing operation by the precision positioning adjuster 14. The inkjet printer 1 prompts the precision positioning adjuster 14 to vertically move the print object holding tool 11 alone during the printing operation, thereby appropriately adjusting the distance between the carriage 103 and the outer surface WS of the print object W during the printing operation.

In this embodiment providing such simplified drivers, the multiple per-print object holders 32 are driven in conjunction with one another by one horizontal axis rotation driver 34 and one vertical axis rotation driver 36. Instead, each one of the per-print object holders 32 may be provided with a horizontal axis rotation driver 34 and a vertical axis rotation driver 36, or the multiple per-print object holders 32 may be driven in conjunction with one another by two or more horizontal axis rotation drivers 34 and vertical axis rotation drivers 36.

In this disclosure, the horizontal mover 13 and the precision positioning adjuster 14 of the transporter 12 may move the carriage 103 mounted with the printing unit 50 in predetermined directions instead of moving the print object holding tool 11, or may move both of the print object holding tool 11 and the carriage 103 mounted with the printing unit 50 in predetermined directions. In this disclosure, the rough positioning adjuster 51 may vertically move the print object holding tool 11 instead of vertically moving the carriage 103 mounted with the printing unit 50, or may vertically move both of the carriage 103 and the print object holding tool 11.

The inkjet printer 1 may be further provided with an imaging unit. The imaging unit captures the image of the mounting position to detect the direction of the print object W loaded in the print object holding tool 11 and adjusts the direction and/or printing position of the print object W based on the detected result.

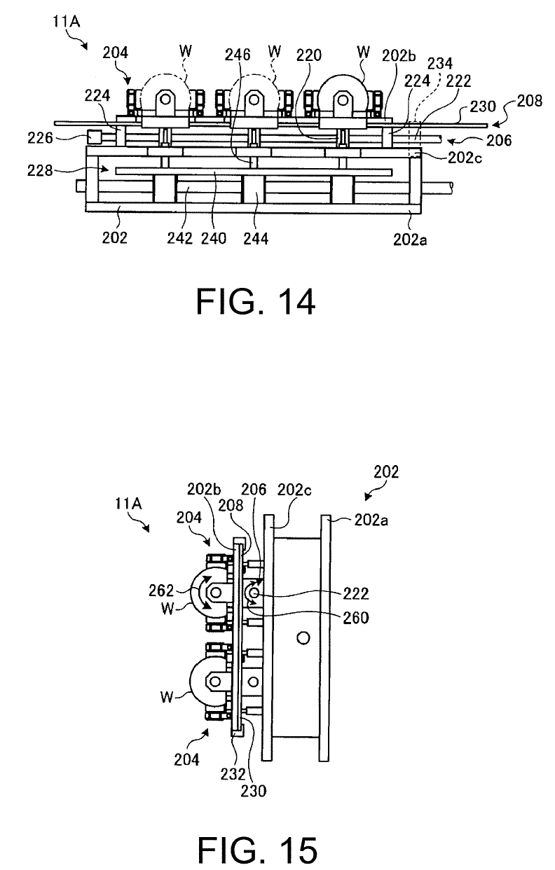

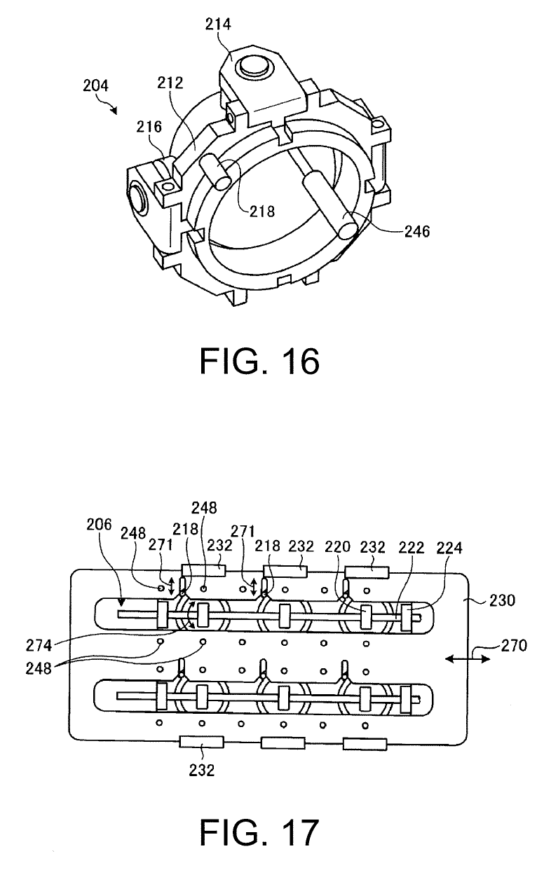

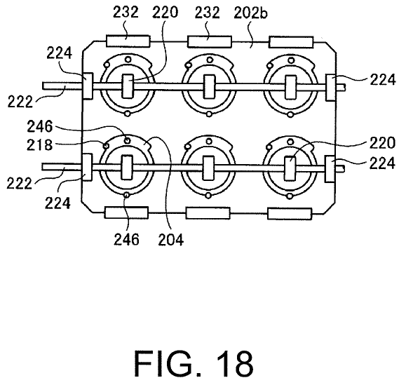

The operation of a print object holding tool according to another embodiment is hereinafter described referring to FIGS. 13 to 18. FIG. 13 is an upper view of the print object holding tool. FIG. 14 is a side view of the print object holding tool. FIG. 15 is a side view of the print object holding tool. FIG. 16 is a perspective view in part of the print object holding tool. FIGS. 17 and 18 are cross-sectional views of the print object holding tool.

A print object holding tool 11A according to this embodiment is equipped to hold six print objects. This number of print objects held by the print object holding tool 11A is a non-limiting example.

The print object holding tool 11A has a base 202, a plurality of per-print object holders 204, a horizontal axis rotation driver 206, and a vertical axis rotation driver 208. The print object holding tool 11A according to this embodiment has six per-print object holders 204. The six per-print object holders 204 are arranged in the matrix of two rows and three columns. Among the per-print object holders 204, three of them in the same row are disposed in alignment. The base 202 is secured to the vertical movement table 25 of the transporter 12. The base 202 supports the per-print object holders 204, horizontal axis rotation driver 206, and vertical axis rotation driver 208. The base 202 has a support plate 202a, a support plate 202b, and a support plate 202c that are arranged in parallel and spaced at predetermined intervals. The support plate 202c is interposed between the support plates 202a and 202b. The support plates 202a, 202b, and 202c are arranged in the mentioned order from the vertically lower side. The support plates 202a, 202b, and 202c are coupled to one another, with their relative positions being fixed, by pillar-shaped members. The support plate 202b has an opening at a position at which the print object W is held.

The per-print object holder 204 has a print object rotator 212, print object holders 214, and a projection 218. The print object rotator 212 is rotatably supported on the support plate 202b. The print object rotator 212 has a circular opening. The opening of the print object rotator 212 is formed at a position overlapping the opening position of the support plate 202b. The print object rotator 212 is rotated about the vertical axis by the vertical axis rotation driver 208. The print object holders 214 are supported on the print object rotator 212. There are four print object holders 214 at intervals spaced apart through 90 degrees along the opening of the print object rotator 212. The print object holders 214 are held in a manner that they are pivotable relative to the print object rotator 212 and are pushed by, for example, springs toward the inner side of the opening. The range of pivoting movement of each print object holder 214 is regulated by a stopper to prevent any movement beyond the range. The print object holders 214 each have, on its opening-side surface, a contact portion 216. The contact portions 216 make contact with the print object W. The contact portions 216 of the print object holders 214 are pushed by springs or the like toward the inner side of the opening. The projection 218 is formed on the surface of the print object rotator 212 closer to the support plate 202b and is projecting from the support plate 202b. The per-print object holder 204 holds the print object W between the contact portions 216 of the print object holders 214 disposed at four positions of the print object rotator 212, thereby holding the print object W at a position at which the center of the print object W coincides with the center line of the opening of the print object rotator 212. The per-print object holder 204, using a holding position selective mechanism 228 of the horizontal axis rotation driver 206 which will be described later, may selectively hold the print object W in either one of the following manners; hold the print object W using all of the four print object holders 214, and hold the print object W using two opposing ones of the print object holders 214 with no contact between the print object W and the other two opposing print object holders 214. The per-print object holder 204, using the holding position selective mechanism 228 of the horizontal axis rotation driver 206, may move the four print object holders 214 away from the print object W to weaken the strengths of the print object holders 214 when they hold the print object W.

The horizontal axis rotation driver 206 rotates the print object W about a horizontally extending axis passing through the center of the print object W. The horizontal axis rotation driver 206 is a common component for all of the six per-print object holders 204. The horizontal axis rotation driver 206 has six rollers 220, two shafts 222, support portions 224, drivers 226, and a holding position selective mechanism 228. The rollers 220 are each disposed on the vertically lower side of the print object rotator 212 of the per-print object holder 204 between the support plates 202b and 202c. The roller 220 has a columnar shape and is disposed so that its axis is horizontally situated. The outer peripheral surface of the roller 220 contacts the print object W held by the print object holders 214. The shafts 222 are inserted through the rollers 220. One of the shafts 222 of the horizontal axis rotation driver 206 is inserted through three of the rollers 220 disposed in the same row. The horizontal axis rotation driver 206 thereby rotates these three rollers 220 in conjunction with one another. The support portions 224 are in contact with the support plates 202b and 202c. The support portions 224 support the shafts 222 in a rotatable manner. The drivers 226 rotate the shafts 222 and thereby rotate the rollers 220 in the directions indicated with arrows 260.

The holding position selective mechanism 228 has a support plate 240, a shaft 242, cams 244, and pins 246. The support plate 240 is interposed between the support plates 202a and 202c. The shaft 242 is interposed between the support plates 202a and 240. The shaft 242 is inserted through the cams 244. The cams 244 are in contact with the support plate 240. The cams 244, by rotating in conjunction with the shaft 242, moves the support plate 240 in directions orthogonal to the support plate 240 and thereby changes the distance between the support plate 240 and the shaft 242. The pins 246 are disposed on the surface of the support plate 240 facing the support plate 202b and protrudes toward the support plate 202b. Insertion holes 248 are formed at positions on the support plate 202b at which the pins 246 are extending and a slide plate 230 of the vertical axis rotation driver 208. The pins 246, with their edges being located at positions facing the print object rotator 212, are inserted in the insertion holes 248. The strengths of the print object holders 214 when they hold the print object W depends on the degree of insertion of the pins 246 toward the print object rotator 212. The holding position selective mechanism 228 rotates the shaft 242 and moves the support plate 240 toward the support plate 202b using the cams 244 to increase the degree of insertion of the pins 246 toward the print object rotator 212 to exceed a predetermined value. This decreases the holding strengths of two of the print object holders 214 disposed in the directions of rotation of the roller 220 (directions orthogonal to the axis of rotation). The holding position selective mechanism 228 draws the support plate 240 away from the support plate 202b using the cams 244 to decrease the degree of insertion of the pins 246 toward the print object rotator 212 to be less than the predetermined value. The holding strengths of two of the print object holders 214 disposed in the directions of rotation of the roller 220 (directions orthogonal to the axis of rotation) are thereby adjusted to be substantially equal to the strengths of the other print object holders 214. A diverse range of mechanisms may be available to increase or decrease the degree of insertion of the pins 246 in order to adjust the print object holders 214 when they hold the print object W. For example, the contact portions 216 may be drawn away from the print object W by inserting the pins 246 and thereby moving the print object holders 214 toward the print object rotator 212. The holding position selective mechanism 228 may be structured such that the strengths of the four print object holders 214 when they push the print object W are weakened than when the degree of insertion of the pins 246 is increased to exceed the predetermined value.

The vertical axis rotation driver 208 has a slide plate 230, a guide rail 232, and a driver 234. The slide plate 230 is adjacent to the support plate 202b. The slide plate 230 moves in directions in which three per-print object holders are arranged (arrows 270) relative to the support plate 202b. The slide plate 230 has grooves for the projections 218 to be fitted in. The grooves are extending in an angled direction relative to the directions in which the slide plate 230 slides. The guide rail 232 is secured to the support plate 202b and supports the slide plate 230 in a manner that the slide plate 230 is slidable in directions indicated with arrows 270. The driver 234 moves the slide plate 230 in the sliding directions relative to the support plate 202b. The vertical axis rotation driver 208 moves the slide plate 230 in the directions of arrows 270 to displace the projections 218 in the directions of arrows 271. Along with the displacement of the projection 218 in the directions of arrows 271, the print object rotator 212 pivots about the opening center in the directions of arrows 272.

The print object holding tool 11A holds the print object W using the four print object holders 214, thereby retaining the print object W on the print object rotator 212. The print object holding tool 11A, with the print object W being held by the four print object holders 214, slides the slide plate 230 of the vertical axis rotation driver 208 in the directions of arrows 270. Then, the projection 218 is displaced along the groove of the slide plate 230, and the print object rotator 212 rotates about the vertical axis in the directions of arrows 272. As the print object rotator 212 rotates, the print object W held in the print object rotator 212 is rotated in the directions of arrows 272. After the strengths of the print object holders 214 when they hold the print object W in the directions of rotation of the roller 220 are weakened by the holding position selective mechanism 228, the print object holding tool 11A rotates the roller 220 using the horizontal axis rotation driver 206, so that the print object W in contact with the roller 220 is rotated in the directions of arrows 262 about a line connecting two contact portions 216 along the axis of rotation of the roller 220.

Thus, the print object W held by the print object holders 214 supported by the print object rotator 212 is rotated by the print object holding tool 11A about the horizontal and vertical axes. This allows different parts of the print objects W held by the print object holding tool 11A to be directed toward the carriage. Such a simplified structure may afford effective change of the print surface of the print object W, leading to an improved efficiency of the printing operation. This structure that allows the print object W to be rotated with substantially no displacement of its center axis may afford quick change of the print surface.

The embodiments thus far described are non-limiting examples of this disclosure. The embodiments described in this disclosure may be carried out in various forms. Some of the technical features described herein may be omitted, or replaced or combined with other features within the scope and spirit of this disclosure.

What is claimed is:

1. A print object holding tool, comprising:
a holder that holds a print object at two opposing parts thereof;
a horizontal axis rotary mechanism that rotates the print object held by the holder about an axis of rotation horizontally situated; and
a vertical axis rotary mechanism that rotates the print object held by the holder about an axis of rotation vertically situated.

2. The print object holding tool according to claim 1, wherein
the horizontal axis rotary mechanism rotates the holder.

3. The print object holding tool according to claim 2, further comprising:
a mounting portion disposed at a vertically lower position relative to the print object held by the holder, wherein
the vertical axis rotary mechanism rotates the mounting portion mounted with the print object unheld by the holder, so as to rotate the print object.

4. The print object holding tool according to claim 2, wherein the holder comprises:
a first contact portion that makes contact with the print object;
a second contact portion that makes contact with a part of the print object opposite to a part of the print object in contact with the first contact portion;
a first mover that linearly moves the first contact portion toward and away from the print object; and
a second mover that linearly moves the second contact portion toward and away from the print object.

5. The print object holding tool according to claim 1, wherein
the horizontal axis rotary mechanism contacts a vertically lower surface of the print object held by the holder and rotates a contacted part of the vertically lower surface, so as to rotate the print object.

6. The print object holding tool according to claim 5, wherein
the vertical axis rotary mechanism rotates the holder which holds the print object, with the print object being set as center of rotation.

7. A inkjet printer, comprising:
the print object holding tool according to claim 1; and
a printing unit that performs inkjet printing of the print object held by the print object holding tool.

8. The inkjet printer according to claim 7, wherein
the printing unit prompts a carriage for the inkjet printing to move for scan in a predetermined direction,
the axis of rotation of the print object by the horizontal axis rotary mechanism is parallel to a direction in which the carriage mounted with the printing unit is moved for scan.
